(19) United States
(12) Patent Application Publication
(10) Pub. No.: US 2008/0175203 A1
(43) Pub. Date: Jul. 24, 2008

(54) Method of enhancing continuous packet connectivity in a wireless communications system and related apparatus

(75) Inventor: Yu-Chih Jen, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited

(21) Appl. No.: 12/010,282

(22) Filed: Jan. 23, 2008

Related U.S. Application Data
(60) Provisional application No. 60/886,292, filed on Jan. 23, 2007.

(51) Int. Cl. H04Q 7/00

(52) U.S. Cl. 370/331; 370/329

(57) ABSTRACT

A method for enhancing a CPC function or a discontinuous operation function in a network of a wireless communications system includes UE configuring a function or only the function of the CPC function or the discontinuous operation function, and determining the configuration of the function or when to adjust the configuration of the function according to operating status of the UE.

### CROSS REFERENCE TO RELATED APPLICATIONS

This application claims the benefit of U.S. Provisional Application No. 60/886,292, filed on Jan. 23, 2007 and entitled “Method and Apparatus to realize Continuous Packet Connectivity and improve discontinuous transmission and reception”, the contents of which are incorporated herein by reference.

### BACKGROUND OF THE INVENTION

1. Field of the Invention

The present invention relates to a method of enhancing continuous packet connectivity in a wireless communications system and related apparatus, and more particularly, to a method and related communications apparatus for enhancing CPC.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting at the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve uplink/downlink transmission rate. For HSDPA and HSUPA, the 3rd Generation Partnership Project (3GPP) provides a Continuous Packet Connectivity (CPC) protocol specification, which includes features that, for user equipments (UEs) in CELL_DCH state, aim to significantly increase the number of packet data users for a cell, reduce the uplink noise rise and improve the achievable download capacity for VoIP.

For an HSDPA UE, physical channels include a high speed physical downlink shared channel (HS-PDSCH), for transferring payload data, and a high speed physical control channel (HS-DPCCH) for uploading an acknowledgement/negative acknowledgement (ACK/NACK) and a channel quality identifier (CQI). As for the media access control (MAC) layer of the HSDPA UE, a MAC-hs entity utilizes a transport channel of High Speed Downlink Shared Channel (HS-DSCH) for receiving data from the physical layer. In addition, a shared control channel for HS-DSCH (HS-SCCH) is used as a physical downlink channel, responsible for transmission of control signals corresponding to HS-DSCH, such as demodulation information.

For an HSUPA UE, physical channels includes two uplink channels: an enhanced dedicated transport channel dedicated physical data channel (E-DPDCH), for transferring payload data, and an E-DCH dedicated physical control channel (E-DPCCH) for transmission of control signals, such as retransmission numbers. Furthermore, a bundle of downlink physical channels are employed in the HSUPA system and used for transmitting control signals associated with grants, ACKs and etc. The downlink physical channels include E-DCH relative grant channel (E-RGCH), E-DCH absolute grant channel (E-AGCH), E-DCH HARQ acknowledgement indicator channel (E-HICH) and fractional dedicated physical channel (F-DPCH). As for the MAC layer of the HSUPA UE, a MAC-e/es entity utilizes a transport channel of enhanced dedicated transport channel (E-DCH) for transmitting MAC packet data to the physical layer with supporting a transmission time interval (TTI) of 10 milliseconds (ms) or 2 ms.

For CELL_DCH state, CPC operation defines an active state and an inactive state. For any data channels (ex. E-DCH), the active state represents that there are data packets transmitted on the data channels. For any control channels (ex. HS-DPCCH), the active state represents that there are data packets transmitted on the data channels corresponding to the control channels, such as HS-PDSCH corresponding to HS-DPCCH. On the contrary, for any data channels, the inactive state represents that there are no data packets transmitted on the data channels. For any control channels, the inactive state represents that there are no data packets transmitted on the data channels corresponding to the control channels.

According to the CPC protocol specification, discontinuous uplink transmission (uplink DTX) is a mechanism where control signals are transmitted on the uplink control channels according to defined discontinuous patterns during the inactive state of corresponding uplink data channels in order to maintain signal synchronization and power control loop with less control signaling. The uplink control channels include a normal DPCCH in addition to the abovementioned uplink control channels of HSUPA and HSDPA.

Moreover, discontinuous uplink reception (uplink DRX) of CPC is utilized to control the UE to transmit E-DCH in specific time interval and has to be configured with uplink DTX. If there has been no E-DCH transmission for a configurable number of transmission time intervals (ex. the interval of UE_Inactivity_Threshold), a radio network controller (RNC) can configure the UE to restrict the start of E-DCH transmission to a MAC_DTX_cycle pattern. UE_DTX_DRX_Offset is also used in uplink DRX, allowing the UEs to have different E-DCH start time.

Furthermore, discontinuous downlink reception (downlink DRX) of CPC is configured by the RNC and allows the UE to restrict the downlink reception times in order to reduce power consumption. When the downlink DRX is enabled, the UE is not required to receive physical downlink channels except for several specific situations.

In addition, CPC includes an HS-SCCH less operation, which is a special mode of HSDPA operation for reducing HS-SCCH overhead for a hybrid automatic repeat request (HARQ) process, thereby reducing UE power consumption. Under this mode, the first HS-DSCH transmission of the HARQ process corresponding to small transport blocks (TBs) on pre-defined HS-DSCH is performed without accompaniment of HS-SCCH signaling, and the HARQ retransmissions corresponding to the first HS-DSCH transmission are accompanied with the HS-SCCH signaling if the retransmissions are needed. Accordingly, the UE needs blind decoding for TB data of the first transmission based on predefined TB size and channel coding set. If blind decoding is success, the UE reports ACK to the base station, also known Node-B, through HS-SCCH; otherwise, the UE reports nothing and waits for retransmission initiated by the Node-B. In order to combine the first transmission with the subsequent retransmissions, the HS-SCCH transmits required control signals of physical channel coding set, TB size, UE identity, a pointer and etc., where the pointer notify the UE of the TTI where the previous transmission has been performed. In addition, The UE can report ACK or NACK for the retransmission, and the retransmission is restricted to two times. The first and second retransmissions can be asynchronous with respect to the first transmission, and with respect to each other. The accompanying HS-SCCH follows the same timing relationship with the HS-PDSCH transmission as legacy transmissions do.

According to related communication protocols, the DTX/DRX configuration is decided by SRNC (Serving Radio Network Controller). However, SRNC may not know or may not use the UEs' activities, mobility or statistics to make the configuration change up-to-date. When long DRX is configured for a UE, it may result in experience of handover procedure delay due to late handover command or update limitation to the UEs. In other words, UEs cannot suggest or acquire reasonable DTX/DRX configuration when they are needed to maintain QoS requirement or service satisfaction. In addition to the desired flexibility of DTX/DRX configuration being introduced at UEs, HS-SCCH less operation or operation with similar purpose also desires certain flexibility for various applications to maintain aforementioned requirement or satisfaction. On the other hand, the update make at both network and UEs should take into account the valid change which should not impact the normal performance or at least have procedures to resolve the possible impacts.

Besides, DTX/DRX characteristics for a UE with MIMO (Multi-Input Multi-Output) has not been explored in the current specifications while the DTX/DRX should be considered as an essential way to save power and radio resource with effiecient scheduling.

In the follow-up communications system, CPC may be less operation of a control channel or discontinuous operation, such as DRX. Besides, control channels applied the less operation can be HS-SCCH or other control channels.

### SUMMARY OF THE INVENTION

According to the present invention, a method for enhancing a CPC function or a discontinuous operation function in a network of a wireless communications system comprises UE configuring a function or only the function of the CPC function or the discontinuous operation function, and determining the configuration of the function or when to adjust the configuration of the function according to operating status of the UE.

According to the present invention, a method for enhancing a CPC function or a discontinuous operation function in UE of a wireless communications system comprises configuring a function or only the function of the CPC function or the discontinuous operation function, and adjusting the configuration of the function or activating or deactivating the function according to at least one measurement result or at least one activation condition of at least one event. According to the present invention, a method for enhancing a CPC function or a discontinuous operation function in a wireless communications system comprises a UE configuring a function or only the function of the CPC function or the discontinuous operation function, and the UE or a network adjusting the configuration of the function according to specified conditions when the UE performs handover.

According to the present invention, a method for enhancing a CPC function or a discontinuous operation function in a network of a wireless communications system comprises setting UE with Multi-input Multi-output, called MIMO hereinafter, capability to use at least one sets of configurations of discontinuous reception or discontinuous transmission function.

According to the present invention, a method for enhancing a CPC function or a discontinuous operation function in UE of a wireless communications system comprises using only single antenna transmission or Space Time Transmit Diversity to support on a fractional dedicated physical channel.

According to the present invention, a communications device for enhancing a CPC function or a discontinuous operation function in a wireless communications system comprises a control circuit for realizing functions of the communications device, a central processing unit installed in the control circuit for executing a program code to operate the control circuit, and a memory coupled to the central processing unit for storing the program code. The program code comprises a UE configuring a function or only the function of the CPC function or the discontinuous operation function, and determining the configuration of the function or when to adjust the configuration of the function according to operating status of the UE.

According to the present invention, a communications device for enhancing a CPC function or a discontinuous operation function in a wireless communications system comprises a control circuit for realizing functions of the communications device, a central processing unit installed in the control circuit for executing a program code to operate the control circuit, and a memory coupled to the central processing unit for storing the program code. The program code comprises configuring a function or only the function of the CPC function or the discontinuous operation function, and adjusting the configuration of the function or activating or deactivating the function according to at least one measurement result or at least one activation condition of at least one event.

According to the present invention, a communications device for enhancing a CPC function or a discontinuous operation function in a wireless communications system comprises a control circuit for realizing functions of the communications device, a central processing unit installed in the control circuit for executing a program code to operate the control circuit, and a memory coupled to the central processing unit for storing the program code. The program code comprises a UE configuring a function or only the function of the CPC function or the discontinuous operation function, and the UE or a network adjusting the configuration of the function according to specified conditions when the UE performs handover.

According to the present invention, a communications device for enhancing a CPC function or a discontinuous operation function in a wireless communications system comprises a control circuit for realizing functions of the communications device, a central processing unit installed in the control circuit for executing a program code to operate the control circuit, and a memory coupled to the central processing unit for storing the program code. The program code comprises setting UE with Multi-input Multi-output, called MIMO hereinafter, capability to use at least one set of configurations of discontinuous reception or discontinuous transmission function.

According to the present invention, a communications device for enhancing a CPC function or a discontinuous operation function in a wireless communications system comprises a control circuit for realizing functions of the communications device, a central processing unit installed in the control circuit for executing a program code to operate the control circuit, and a memory coupled to the central processing unit for storing the program code. The program code comprises using only single antenna transmission or Space Time Transmit Diversity to support on a fractional dedicated physical channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 to FIG. 7 are flowchart diagrams of processes according to embodiments of the present invention.

### DETAILED DESCRIPTION

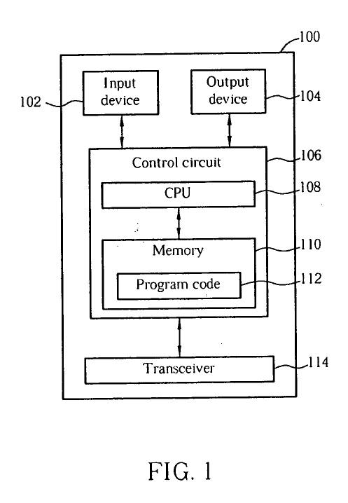

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a High Speed Package Access (HSPA) system of the third generation (3G) mobile communications system, LTE system, or other related communications system, and can be user or network equipment.

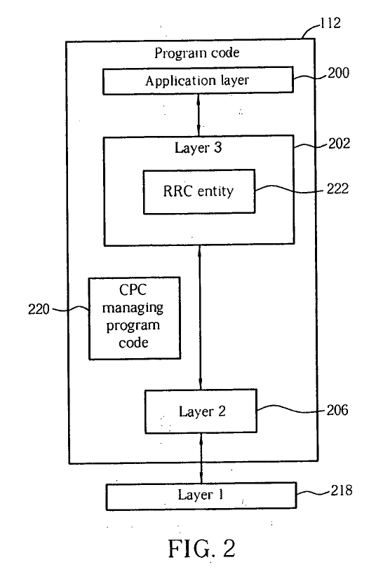

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 includes a radio resource control (RRC) entity 222, which is used for controlling the Layer 1 218 and the Layer 2 206. In addition, when the communications device 100 implements a user equipment, the RRC entity 222 can change an RRC state according to system requirements or radio conditions, to switch between an RRC_IDLE state and an RRC_CONNECTED state. The RRC_CONNECTED state can be CELL_PCH, URA_PCH, CELL_FACH or CELL_DCH state in 3G system.

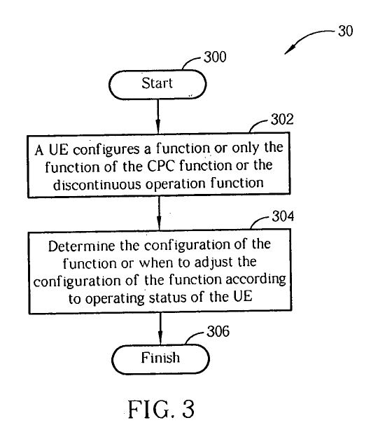

As mentioned above, for UEs in CELL_DCH state, the network can configure CPC to significantly increase the number of packet data users for a cell, reduce the uplink noise rise and improve the achievable download capacity for VoIP. CPC includes mechanisms of uplink DTX, uplink DRX, downlink DRX, and HS-SCCH less operation, for reducing UE power consumption. In such a situation, the embodiment of the present invention provides a CPC managing program code 220 to avoid system malfunction. Please refer to FIG. 3, which illustrates a schematic diagram of a process 30 according to an embodiment of the present invention. The process 30 is utilized for enhancing CPC in a network of a wireless communications system, and can be compiled into the CPC managing program code 220. The process 30 comprises the following steps:
Step 300: Start.
Step 302: A UE configures a function or only the function of the CPC function or the discontinuous operation function.
Step 304: Determine the configuration of the function or when to adjust the configuration of the function according to operating status of the UE.
Step 306: Finish.

According to the process 30, the network can determine the configuration of the function or when to adjust the configuration of the function according to operating status of the UE. The function can be a discontinuous uplink transmission function, a discontinuous uplink reception function, a discontinuous downlink reception function, or a less operation of control channel. For example, the embodiment of the present invention can determine when to adjust the configuration of the function, activate or deactivate the function according to UE statistics, capability, mobility, system load, or possible scheduling.

In addition, when the UE has configured the discontinuous uplink transmission function, discontinuous uplink reception function, or discontinuous downlink reception function, the embodiment of the present invention can increase a rate of sending measurement report by setting cycles of the discontinuous uplink transmission function or the discontinuous uplink reception function, or setting a UE_Inactivity_Threshold parameter to 0, according to measurement reports sent by the UE.

Therefore, via the process 30, the network can determine when to adjust configurations of discontinuous uplink transmission function, discontinuous uplink reception function, discontinuous downlink reception function or HS-SCCH less operation according to the operating status of the UE.

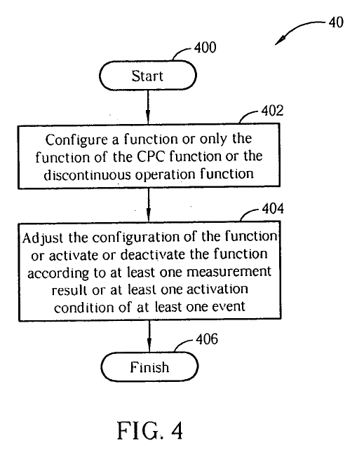

Please refer to FIG. 4, which illustrates a schematic diagram of a process 40 according to an embodiment of the present invention. The process 40 is utilized for enhancing CPC in a UE of a wireless communications system, and can be compiled into the CPC managing program code 220. The process 40 comprises the following steps:
Step 400: Start.
Step 402: Configure a function or only the function of the CPC function or the discontinuous operation function.
Step 404: Adjust the configuration of the function or activate or deactivate the function according to at least one measurement result or at least one activation condition of at least one event.
Step 406: Finish.

According to the process 40, after the UE configures a function of the CPC function, such as a discontinuous uplink transmission function, a discontinuous uplink reception function, a discontinuous downlink reception function, or a less operation of a control channel, the UE adjust the configuration of the function according to at least one measurement result. In other words, the UE can adjust or suggest the configurations of discontinuous uplink transmission function, discontinuous uplink reception function, discontinuous downlink reception function, or less operation of a control channel.

Preferably, each of the at least one measurement result is corresponding to a threshold value for adjusting, activating or deactivating the function. When the at least one measurement result do not conform to a threshold value, the UE can adjust or suggest the configuration of the function or activating or deactivating the function. Besides, the UE can suggest the configuration of the function according to measurement result, statistics, transmission status, transmission requirement, capability, or mobility.

In addition, if the UE only configures the discontinuous reception function and the HS-SCCH less operation, the UE does not update or indicate values of at least one discontinuous reception function, which make retransmission incapable of being processed or scheduled within a predefined period (13 TTI) or at a specified cycle. Moreover, if the UE can indicate the network to deactivate the function or trigger handover when the UE cannot successfully trigger adjustment of the configuration of the function or suggest the configuration of the function, and wait for an acknowledgement signal or indication corresponding to the indication signal from the network.

Therefore, via the process 40, after the UE configures the discontinuous uplink transmission function, discontinuous uplink reception function, discontinuous downlink reception function, or HS-SCCH less operation, the UE can adjust or suggest the configurations according to measurement results.

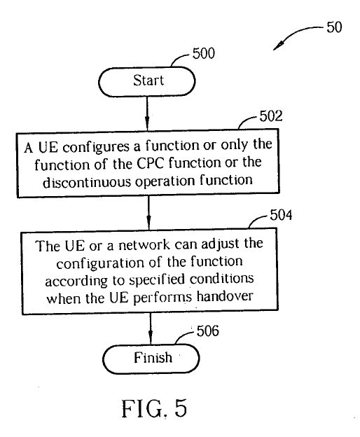

Please refer to FIG. 5, which illustrates a schematic diagram of a process 50 according to an embodiment of the present invention. The process 50 is utilized for enhancing CPC in a wireless communications system, and can be compiled into the CPC managing program code 220. The process 50 comprises the following steps:
Step 500: Start.
Step 502: A UE configures a function or only the function of the CPC function or the discontinuous operation function.
Step 504: The UE or a network can adjust the configuration of the function according to specified conditions when the UE performs handover.
Step 506: Finish.

According to the process 50, after the UE configures a discontinuous uplink transmission function, a discontinuous uplink reception function, a discontinuous downlink reception function, or a HS-SCCH less operation, the UE or the network can adjust the configuration of the function according to specified conditions when the UE performs handover. The specified conditions can be UE statistics, capability, mobility, system load, or scheduling.

Therefore, via the process 50, when the UE performs handover, the UE or the network can adjust the configurations of the discontinuous uplink transmission function, discontinuous uplink reception function, discontinuous downlink reception function, or HS-SCCH less operation according to UE statistics, capability, mobility, system load, scheduling.

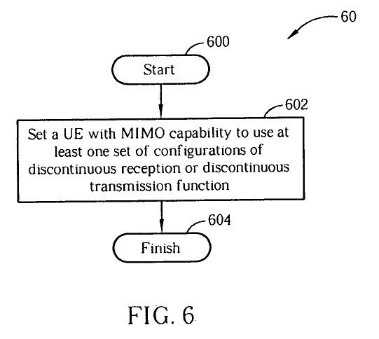

Please refer to FIG. 6, which illustrates a schematic diagram of a process 60 according to an embodiment of the present invention. The process 60 is utilized for enhancing CPC in a network of a wireless communications system, and can be compiled into the CPC managing program code 220. The process 60 comprises the following steps:
Step 600: Start.
Step 602: Set a UE with MIMO capability to use at least one set of configurations of discontinuous reception or discontinuous transmission function.
Step 604: Finish.

According to the process 60, for a MIMO UE, the network can set the UE to use at least one set of configurations of discontinuous reception or discontinuous transmission function. As a result, each set of uplink and downlink can use a corresponding set of configurations of discontinuous reception or discontinuous transmission function. Preferably, each of the at least one sets of the configurations of the discontinuous reception or discontinuous transmission function can be independent or time-related.

Moreover, the network can preferably adjust the at least one sets of the configurations of the discontinuous reception or discontinuous transmission function according to a MIMO mode, buffer status, application requirement, or authorized intervals of the UE, and output a command corresponding to activation or deactivation of the discontinuous reception or discontinuous transmission function according to the MIMO mode of the UE when the UE uses the at least one set of discontinuous reception or discontinuous transmission function. The command preferably comprises at least three bits.

Therefore, via the process 60 the MIMO UE can use at least one set of configurations of discontinuous reception or discontinuous transmission function.

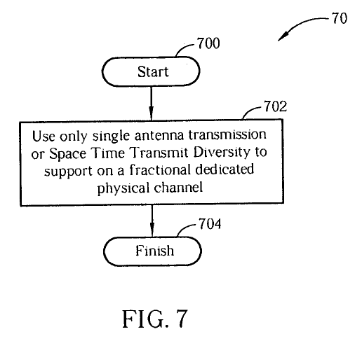

Please refer to FIG. 7, which illustrates a schematic diagram of a process 70 according to an embodiment of the present invention. The process 70 is utilized for enhancing CPC in a UE of a wireless communications system, and can be compiled into the CPC managing program code 220. The process 70 comprises the following steps:
Step 700: Start.
Step 702: Use only single antenna transmission or Space Time Transmit Diversity to support on a fractional dedicated physical channel.
Step 704: Finish.

According to the process 70, for a MIMO UE, the embodiment of the present invention uses only single antenna transmission or Space Time Transmit Diversity to support on F-DPCH.

In summary, the present invention provides different embodiments for enhancing CPC.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing a Continuous Packet Connectivity, called CPC hereinafter, function or a discontinuous operation function in a network of a wireless communications system comprising:
a user equipment, called UE hereinafter, configuring a function or only the function of the CPC function or the discontinuous operation function; and
determining the configuration of the function or when to adjust the configuration of the function according to operating status of the UE.

2. The method of claim 1, wherein the function of the CPC function or the discontinuous operation function is a discontinuous uplink transmission function, a discontinuous uplink reception function, a discontinuous downlink reception function, or a less operation of control channel.

3. The method of claim 1, wherein determining the configuration of the function or when to adjust the configuration of the function according to operating status of the UE is determining when to adjust the configuration of the function according to UE statistics, capability, mobility, system load, or possible scheduling.

4. The method of claim 1, wherein determining the configuration of the function or when to adjust the configuration of the function according to operating status of the UE further comprising determining when to activate or deactivate the function according to operating status of the UE.

5. The method of claim 1 further comprising increasing a rate of sending measurement report when the UE triggers a discontinuous uplink transmission function, a discontinuous uplink reception function, or a discontinuous downlink reception function of the CPC function.

6. The method of claim 5, wherein increasing the rate of sending measurement report is increasing the rate of sending measurement report by setting cycles of the discontinuous uplink transmission function or the discontinuous uplink reception function.

7. The method of claim 5, wherein increasing the rate of sending measurement report is setting a UE_Inactivity_Threshold parameter to 0.

8. The method of claim 5, wherein increasing the rate of sending measurement report is increasing the rate of sending measurement report according to measurement reports sent by the UE.

9. A method for enhancing a Continuous Packet Connectivity, called CPC hereinafter, function or a discontinuous operation function in a user equipment, called UE hereinafter, of a wireless communications system comprising:
configuring a function or only the function of the CPC function or the discontinuous operation function; and
adjusting the configuration of the function or activating or deactivating the function according to at least one measurement result or at least one activation condition of at least one event.

10. The method of claim 9, wherein the function of the CPC function or the discontinuous operation function is a discontinuous uplink transmission function, a discontinuous uplink reception function, a discontinuous downlink reception function, or a less operation of control channel.

11. The method of claim 9, wherein adjusting the configuration of the function or activating or deactivating the function according to the at least one measurement result is adjusting the configuration of the function or activating or deactivating the function when the at least one measurement result do not conform to a threshold value.

12. The method of claim 9, wherein adjusting the configuration of the function or activating or deactivating the function according to the at least one activation condition of the at least one event is adjusting the configuration of the function or activating or deactivating the function when the at least one activation condition of the at least one event occur.

13. The method of claim 11, wherein the UE suggests the configuration of the function according to measurement result, statistics, transmission status, transmission requirement, capability, or mobility.

14. The method of claim 11, wherein each of the at least one measurement result is corresponding to a threshold value for adjusting, activating or deactivating the function.

15. The method of claim 11, wherein activation of the at least one event is corresponding to the at least one activation condition each utilized for adjusting, activating or deactivating the function.

16. The method of claim 15, wherein the at least one event is uplink transmission when the at least one activation condition is requirement of uploading measurement results or other uplink messages.

17. The method of claim 11, wherein the function of the CPC function comprises a discontinuous reception function and a less operation of a control channel, and the UE does not update or indicate values of at least one discontinuous reception function, which make retransmission incapable of being processed or scheduled within a predefined period or at a specified cycle.

18. The method of claim 17, wherein the predefined period is buffer length, size of a transmitting window, or a specified transmission time interval, and the specified cycle is a synchronization cycle.

19. The method of claim 11 further comprising indicating a network to deactivate the function or trigger handover when the UE cannot successfully trigger adjustment of the configuration of the function or suggest the configuration of the function.

20. The method of claim 19, wherein indicating a network to deactivate the function or trigger handover is performed by sending an indication signal.

21. The method of claim 20 further comprising waiting for an acknowledgement signal or indication corresponding to the indication signal from the network.

22. A method for enhancing a Continuous Packet Connectivity, called CPC hereinafter, function or a discontinuous operation function in a wireless communications system comprising:
a user equipment, called UE hereinafter, configuring a function or only the function of the CPC function or the discontinuous operation function; and
the UE or a network adjusting the configuration of the function according to specified conditions when the UE performs handover.

23. The method of claim 22, wherein the function of the CPC function is a discontinuous uplink transmission function, a discontinuous uplink reception function, a discontinuous downlink reception function, or a less operation of control channel.

24. The method of claim 22, wherein the specified conditions are UE statistics, capability, mobility, system load, or scheduling.

25. A method for enhancing a Continuous Packet Connectivity, called CPC hereinafter, function or a discontinuous operation function in a network of a wireless communications system comprising:
setting a user equipment, called UE hereinafter, with Multi-input Multi-output, called MIMO hereinafter, capability to use at least one sets of configurations of discontinuous reception or discontinuous transmission function.

26. The method of claim 25, wherein the at least one sets of the configurations of the discontinuous reception or discontinuous transmission function comprises a timing relationship between uplink and downlink.

27. The method of claim 26, wherein each of the at least one sets of the configurations of the discontinuous reception or discontinuous transmission function can be independent or time-related.

28. The method of claim 25 further comprising adjusting the at least one sets of the configurations of the discontinuous reception or discontinuous transmission function according to a MIMO mode, buffer status, application requirement, or authorized intervals of the UE.

29. The method of claim 25 further comprising outputting a command corresponding to activation or deactivation of the discontinuous reception or discontinuous transmission function according to a MIMO mode of the UE when the UE uses the at least one set of discontinuous reception or discontinuous transmission function.

30. The method of claim 29, wherein the command comprises at least three bits.

31. A method for enhancing a Continuous Packet Connectivity, called CPC hereinafter, function or a discontinuous operation function in a user equipment, called UE hereinafter, of a wireless communications system comprising:
using only single antenna transmission or Space Time Transmit Diversity to support on a fractional dedicated physical channel.

32. A communications device for enhancing a Continuous Packet Connectivity, called CPC hereinafter, function or a discontinuous operation function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
a user equipment, called UE hereinafter, configuring a function or only the function of the CPC function or the discontinuous operation function; and
determining the configuration of the function or when to adjust the configuration of the function according to operating status of the UE.

33. The communications device of claim 32, wherein the function of the CPC function or the discontinuous operation function is a discontinuous uplink transmission function, a discontinuous uplink reception function, a discontinuous downlink reception function, or a less operation of control channel.

34. The communications device of claim 32, wherein determining the configuration of the function or when to adjust the configuration of the function according to operating status of the UE is determining when to adjust the configuration of the function according to UE statistics, capability, mobility, system load, or possible scheduling.

35. The communications device of claim 32, wherein determining the configuration of the function or when to adjust the configuration of the function according to operating status of the UE further comprising determining when to activate or deactivate the function according to operating status of the UE.

36. The communications device of claim 32, wherein the program code further comprises increasing a rate of sending measurement report when the UE triggers a discontinuous uplink transmission function, a discontinuous uplink reception function, or a discontinuous downlink reception function of the CPC function.

37. The communications device of claim 36, wherein increasing the rate of sending measurement report is increasing the rate of sending measurement report by setting cycles of the discontinuous uplink transmission function or the discontinuous uplink reception function.

38. The communications device of claim 36, wherein increasing the rate of sending measurement report is setting a UE_Inactivity_Threshold parameter to 0.

39. The communications device of claim 36, wherein increasing the rate of sending measurement report is increasing the rate of sending measurement report according to measurement reports sent by the UE.

40. A communications device for enhancing a Continuous Packet Connectivity, called CPC hereinafter, function or a discontinuous operation function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
configuring a function or only the function of the CPC function or the discontinuous operation function; and
adjusting the configuration of the function or activating or deactivating the function according to at least one measurement result or at least one activation condition of at least one event.

41. The communications device of claim 40, wherein the function of the CPC function or the discontinuous operation function is a discontinuous uplink transmission function, a discontinuous uplink reception function, a discontinuous downlink reception function, or a less operation of control channel.

42. The communications device of claim 40, wherein adjusting the configuration of the function or activating or deactivating the function according to the at least one measurement result is adjusting the configuration of the function or activating or deactivating the function when the at least one measurement result do not conform to a threshold value.

43. The communications device of claim 40, wherein adjusting the configuration of the function or activating or deactivating the function according to the at least one activation condition of the at least one event is adjusting the configuration of the function or activating or deactivating the function when the at least one activation condition of the at least one event occur.

44. The communications device of claim 42, wherein the UE suggests the configuration of the function according to measurement result, statistics, transmission status, transmission requirement, capability, or mobility.

45. The communications device of claim 42, wherein each of the at least one measurement result is corresponding to a threshold value for adjusting, activating or deactivating the function.

46. The communications device of claim 42, wherein activation of the at least one event is corresponding to the at least one activation condition each utilized for adjusting, activating or deactivating the function.

47. The communications device of claim 46, wherein the at least one event is uplink transmission when the at least one activation condition is requirement of uploading measurement results or other uplink messages.

48. The communications device of claim 42, wherein the function of the CPC function comprises a discontinuous reception function and a less operation of a control channel, and the UE does not update or indicate values of at least one discontinuous reception function, which make retransmission incapable of being processed or scheduled within a predefined period or at a specified cycle.

49. The communications device of claim 48, wherein the predefined period is buffer length, size of a transmitting window, or a specified transmission time interval, and the specified cycle is a synchronization cycle.

50. The communications device of claim 42, wherein the program code further comprises indicating a network to deactivate the function or trigger handover when the UE cannot successfully trigger adjustment of the configuration of the function or suggest the configuration of the function.

51. The communications device of claim 50, wherein indicating a network to deactivate the function or trigger handover is performed by sending an indication signal.

52. The communications device of claim 51, wherein the program code further comprises waiting for an acknowledgement signal or indication corresponding to the indication signal from the network.

53. A communications device for enhancing a Continuous Packet Connectivity, called CPC hereinafter, function or a discontinuous operation function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
a user equipment, called UE hereinafter, configuring a function or only the function of the CPC function or the discontinuous operation function; and
the UE or a network adjusting the configuration of the function according to specified conditions when the UE performs handover.

54. The communications device of claim 53, wherein the function of the CPC function is a discontinuous uplink transmission function, a discontinuous uplink reception function, a discontinuous downlink reception function, or a less operation of control channel.

55. The communications device of claim 53, wherein the specified conditions are UE statistics, capability, mobility, system load, or scheduling.

56. A communications device for enhancing a Continuous Packet Connectivity, called CPC hereinafter, function or a discontinuous operation function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
setting a user equipment, called UE hereinafter, with Multi-input Multi-output, called MIMO hereinafter, capability to use at least one sets of configurations of discontinuous reception or discontinuous transmission function.

57. The communications device of claim 56, wherein the at least one sets of the configurations of the discontinuous reception or discontinuous transmission function comprises a timing relationship between uplink and downlink.

58. The communications device of claim 57, wherein each of the at least one sets of the configurations of the discontinuous reception or discontinuous transmission function can be independent or time-related.

59. The communications device of claim 56, wherein the program code further comprises adjusting the at least one sets of the configurations of the discontinuous reception or discontinuous transmission function according to a MIMO mode, buffer status, application requirement, or authorized intervals of the UE.

60. The communications device of claim 56, wherein the program code further comprises outputting a command corresponding to activation or deactivation of the discontinuous reception or discontinuous transmission function according to a MIMO mode of the UE when the UE uses the at least one set of discontinuous reception or discontinuous transmission function.

61. The communications device of claim 60, wherein the command comprises at least three bits.

62. A communications device for enhancing a Continuous Packet Connectivity, called CPC hereinafter, function or a discontinuous operation function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
using only single antenna transmission or Space Time Transmit Diversity to support on a fractional dedicated physical channel.
